(19) United States
(12) Patent Application Publication
(10) Pub. No.: US 2026/0234423 A1
(43) Pub. Date: Aug. 13, 2026

(54) POLYSILOXANE MICA BLEND

(71) Applicant: Dow Silicones Corporation, Midland, MI (US)

(72) Inventors: Peng-Fei Fu, Midland, MI (US); Yanhu Wei, Midland, MI (US)

(21) Appl. No.: 19/153,439

(22) PCT Filed: Jan. 26, 2024
(86) PCT No.: PCT/US2024/013027

§ 371 Date: Aug. 4, 2025

Related U.S. Application Data
(60) Provisional application No. 63/443,802, filed on Feb. 7, 2023.

(51) Int. Cl. C09D 7/61; C08G 77/00; C08G 77/04; C08K 3/34; C09D 183/04

(52) U.S. Cl. CPC C09D 7/61; C08G 77/04; C09D 183/04; C08G 77/80; C08K 2003/343

(57) ABSTRACT

The present invention is a composition comprising a mixture of mica and a T^{R}-D^{R′R′}-(R″MeSiO_{2/2})ₙ copolymer where R, R′, R″, and n are defined herein. The composition is useful as a coating for a substrate, which coating exhibits good adhesion and crack-resistance when subjected to high temperatures for several weeks.

### BACKGROUND OF THE INVENTION

The present invention relates to a silicone coating composition, more particularly a composition that is resistant to cracking and dielectric degradation at high temperatures, and a method for preparing the composition. High temperature protective coatings and insulating materials to protect a variety of equipment and devices against extremely high temperatures. Heater elements for electric vehicles, exhaust systems for automotive engines, power plants, and top coatings for stoves, for example, all benefit from such protective coatings. In many applications, the coating layers must withstand temperatures exceeding 300° C. over several months without cracking or losing dielectric and insulating properties and must pass aggressive thermal shock tests over a broad temperature range.

High temperature resistance of silicones ostensibly makes them promising candidates as high temperature protective coatings and sealants; nevertheless, silicone rubbers are not resistant to cracking above 250° C. beyond 2 weeks. The combination of silicone and inorganic filler such as SiO₂, TiO₂, and Al₂O₃ provides a composition with long term high temperature resistance; however, coatings prepared from such compositions require aging at temperatures exceeding 500° C. to form ceramic-like coatings. At such extreme temperatures, the coatings are likely to crack and suffer thermal shock failure; moreover, electronic elements beneath the surface of the coating are vulnerable to damage. It would therefore be an advance in the field of high temperature protective coatings to develop a composition that provides a coating that is resistant to cracking, delamination, and thermal shock failure, while maintaining acceptable dielectric properties at temperatures exceeding 300° C. for an extended period.

### SUMMARY OF THE INVENTION

The present invention addresses a need in the art by providing a composition comprising a mixture of a mica and a T^{R}-D^{R′R′}-(R″MeSiO_{2/2})ₙ copolymer, where each R, R′, and R″ are independently methyl or phenyl, wherein n is in the range of from 2 to 800, wherein the weight-to-weight ratio of the T^{R}-D^{R′R′}. (R″MeSiO_{2/2})ₙ copolymer to the mica is in the range of from 10:90 to 90:10. The composition of the present invention is useful as a coating for a substrate, wherein the coating exhibits good adhesion, and crack-resistance when subjected to high temperatures for several weeks.

### DETAILED DESCRIPTION OF THE INVENTION

The present invention is a composition comprising a mixture of a mica and a T^{R}-D^{R′R′}-(R″MeSiO_{2/2})ₙ copolymer, where each R, R′, and R″ are independently methyl or phenyl, wherein n is in the range of from 2 to 800, wherein the weight-to-weight ratio of the T_{R}-D^{R′R′}-(R″MeSiO_{2/2})ₙ copolymer to the mica is in the range of from 10:90 to 90:10 . . .

The term “T_{R}-D^{R′R′}-(R″MeSiO_{2/2})ₙ copolymer” refers to a copolymer of a T_{R}-D^{R′R′} resin and a silanol- or C₁-C₄-alkoxy terminated (R″MeSiO_{2/2})ₙ polymer. A T_{R}-D^{R′R′} resin is kinetically stable three-dimensional polymer having repeat units of R—SiO_{3/2}, R—SiO_{2/2}(OZ), and optionally R—SiO_{1/2} (OZ)₂ (collectively T^{R}); and R′2SiO_{2/2} (D^{R′R′}).

A unit of R—SiO_{3/2} is represented by the following structure:

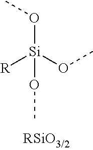

where each R is methyl or phenyl.

R—SiO_{2/2}(OZ) is represented by the following structure:

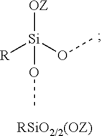

where Z is H, C₁-C₄-alkyl, or C(O)CH₃; and a unit of RSiO_{1/2} (OZ)₂ is represented by the following structure:

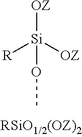

Each Z in the T^{R} portion of the resin is preferably methyl or H.

A unit of R′₂SiO_{2/2} is represented by the following structure:

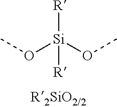

where each R′ is independently methyl or phenyl.

The term “silanol- or C₁-C₄-alkoxylated (R″MeSiO_{2/2})ₙ polymer” refers to a polyphenymethylsiloxane (PPhMS) or polydimethylsiloxane (PDMS) that contains the following repeat units:

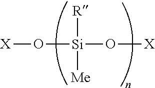

repeat units of siloxane groups
   where X is either H or C₁-C₄-alkyl; and n (alternatively, the degree of polymerization or DP) is preferably from 2 or from 5 or from 20 or from 40 or from 70 or from 100, to 800 or to 500 or to 300 or to 200. The weight-to-weight ratio of the units of the T^{R}-D^{R′R′} resin to the units of the (R″MeSiO_{2/2})ₙ polymer is preferably in the range of from 20:80 or from 30:70 to 80:20 or to 70:30.

The T^{R}-D^{R′R′}-(R″MeSiO_{2/2})ₙ copolymer may be prepared by first mixing in a suitable solvent and under reaction conditions a T^{R}-D^{R′R′} resin, a silanol- or alkoxy-terminated (R″MeSiO_{2/2})ₙ polymer and a crosslinking agent, wherein the crosslinking agent is preferably an acetoxylating or alkoxylating agent. Examples of suitable acetoxylating agents include alkyltriacetoxysilanes such as methyltriacetoxysilane and ethyltriacetoxysilane; suitable alkoxylating agents include phenyltrimethoxysilane, phenyltriethoxysilane, methyltrimethoxysilane, ethyltrimethoxysilane, methyltriethoxysilane, and ethyltriethoxysilane. A commercial example of an acetoxylating agent is XIAMETER™ OSF-1579 Silane (A Trademark of The Dow Chemical Company and its Affiliates), which is a 50:50 w/w blend of methyltriacetoxysilane and ethyltriacetoxysilane. Suitable solvents include aprotic solvents such as ethyl acetate, propyl acetate, propyl proprionate, butyl acetate, and propylene glycol methyl ether acetate (PGMEA).

The acetoxy or alkoxy terminated (R″MeSiO_{2/2})ₙ polymer formed from the reaction of the silanol- or alkoxy-terminated (R″MeSiO_{2/2})ₙ polymer and a crosslinking agent is then advantageously contacted with the T^{R}-D^{R′R′} resin and additional solvent at an advanced temperature to partially or completely convert the T^{R}-D^{R′R′} resin to a T^{R}-D^{R′R′} (R″MeSiO_{2/2}) n copolymer, and to completely consume or nearly completely consume the acetoxy or alkoxy terminated (R″MeSiO_{2/2})ₙ polymer. Volatiles can be removed from the mixture to form a blend of copolymer and free T^{R}-D^{R′R′} resin that can be used without further purification. Micas are hydrated aluminum silicate minerals including muscovite, biotite, fuchsite, phlogopite, margarite, glauconite, and lepidolite micas, of which muscovite mica and phlogopite mica are predominant. The w/w ratio of the mica to the sum of the T^{R}-D^{R′R′}-(R″MeSiO_{2/2}) n copolymer and free T^{R}-D^{R′R′} resin is in the range of from 90:10 or from 80:20 or from 70:30, or from 65:35, to 10:90 or to 20:80 or to 30:70 or to 35:65.

In another aspect of the present invention, the composition comprises a combination of a T^{R}-D^{R′R′}-(R″MeSiO_{2/2})ₙ copolymer; a mica; R²Si(OR₃)₃, where R² is C₁-C₁₂-alkyl or aryl, and R³ is C₁-C₄-alkyl, such as methyltrimethoxysilane, phenyltrimethoxysilane, methyltriethoxysilane, and ethyltrimethoxysilane; an aprotic solvent such as propylene glycol methyl ether acetate, ethyl acetate, propyl acetate, butyl acetate or propyl propionate; and a moisture cure catalyst, for example, a tin-based catalyst such as tin octanoate or tin butanoate, or a titanium-based catalyst such as tetraisopropyl titanate, tetra-n-butyl titanate, and tetra-t-butoxy titanate.

The amount of aprotic solvent is sufficient to achieve a Brookfield viscosity at 25° C. in the range of from 20 cP or from 50 cP or from 100 cP, to 20,000 cP or to 10,000 cP or to 5,000 cP, or to 1200 cP; alternatively, the concentration of aprotic solvent is in the range of from 5 or from 10 or from 20 weight percent, to 90 or to 75 or to 60 weight percent, based on the weight of the composition. In yet another aspect, the present invention is a process for preparing a cured coating on a substrate. The present invention is also an article comprising a substrate coated with the cured composition. The thickness of the coating is generally in the range of from 20 μm to 300 μm.

The composition of the present invention provides a coating for a substrate such as a metal, a metal oxide, a ceramic, or a plastic substrate, that is tack-free in less than 30 minutes at ambient temperature, and thermally stable to cracking for hundreds or even thousands of hours.

### EXAMPLES

### Intermediate Example 1—Preparation of Resin 1 (D^{MeMe}_{0.05}T_{0.10}T^{Ph}_{0.70})

Water (2.5 moles) was added slowly at room temperature to a vessel containing a mixture of Me₂SiCl₂ (0.15 mole), Ph₂SiCl₂ (0.05 mol), MeSiCl₃ (0.10 mole), and PhSiCl₃ (0.70 mole) in toluene. The mixture was heated at 60° C. for 4 h to obtain a solution containing the T^{R}D^{R′R′} resin. The solution was washed with water to remove acid, then stripped under vacuum and heat to produce a solid resin, which was then converted to a resin flake by crushing.

### Intermediate Example 2—Preparation of Resin 2 (D^{MeMe}_{0.15}T^{Me}_{0.40} T^{PH}_{0.45})

Water (2.5 moles) was added slowly at room temperature to a vessel containing a mixture of Me₂SiCl₂ (0.15 mole), PhSiCl₃ (0.45 mole), and MeSiCl₃ (0.40 mole) in toluene. The mixture was heated at 60° C. for 4 h to obtain a solution containing the T^{R}D^{R′R′} resin. The solution was washed with water to remove acid, then stripped under vacuum and heat to produce a solid resin, which was then converted to a resin flake by crushing.

### Intermediate Example 3—Preparation of a Resin 1/PPhMS Copolymer

A silanol-terminated PPhMS (50 g, DP=140), XIAMETER™ OSF-1579 Silane (OSF-1579, 5 g), and butyl acetate (5 g) were added with stirring and under N₂ to a 500-mL 3N dry flask equipped with a Dean-Stark apparatus. The mixture was stirred at room temperature for 1 h, after which time Resin 1 (50 g) and butyl acetate (120 g) were added to the reaction mixture. The mixture was heated to reflux (about 126° C.) for 3 h during which time ~1.8 g of water and 105 g of organic solvent were removed. The mixture was cooled to room temperature and poured into a glass bottle as the final product (70 wt % solids).

### Intermediate Example 4—Preparation of a Resin 2/PPhMS Copolymer

The procedure for Intermediate Example 3 was repeated except that Resin 2 (45 g) was used. The solids content of the final product was 68 wt %.

### Intermediate Example 5—Preparation of a Resin 1/PDMS Copolymer

A silanol-terminated PDMS (50 g, DP=80), (OSF-1579, 5 g), and butyl acetate (5 g) were added with stirring and under N₂ to a 500-mL 3N dry flask equipped with a Dean-Stark apparatus. Resin 2 (50 g) and butyl acetate (120 g) were added to the reaction mixture, followed by heating to reflux for 3 h, during which time ~1.8 g of water and 105 g of organic solvent were removed. The reaction was cooled to room temperature and poured into a glass bottle as the final product (67 wt % solids).

### Comparative Examples 1-3—Preparation of T^{R}D^{R′R′} Resin-Copolymer Blend

Each of Comparative Example was prepared as follows: Intermediate 3, 4, or 5 copolymers (100 pbw) were added under N₂ to a flask with methyltrimethoxysilane (5 pbw) and n-butyl acetate (30 pbw) followed by the addition of tetraisopropyl titanate (1 pbw). The contents of the flask were stirred for 1 h, then poured it into a glass bottle and sealed under N₂.

### Examples 1-3—Preparation of T^{R}D^{R′}-(RMeSiO_{2/2})₁₂₀ Copolymer and Mica Blend

Each example was prepared as follows: C-4000 muscovite mica (K₂Al₄ (A₂Si₆O₂₀)(OH)₄ (median particle size 10.8 μm, obtained from IMERYS) or MRX muscovite mica (median particle size 11.4 μm) was dried in vacuo at 120° C. for 10 h, then cooled to room temperature under N₂. The dried mica (100 pbw) was added to a vessel containing the contents of the Comparative Example and additional n-butyl acetate (30 pbw). The contents of the vessel were mixed by mechanical stirring under N₂. The mixture was then poured into a bottle and sealed for further use.

### Preparation of Coatings

Aluminum panels (Type A from Gardco, 3″×6″) were washed with toluene and acetone and dried by air flow before use. A portion of the prepared formulation (2 g) was coated on the panel to form a film with a thickness in the range of from 50 μm to 100 μm films using a 4-mil drawdown bar. The coated films were dried at 70° C. for 30 min under air flow to remove solvents. The dry films were cured at room temperature or 200° C. for 10 min to 60 min, followed by thermally aging at 300° C.

### Measurement of Cracking Time

The cured coatings were aged in an oven at 300° C. In the first 14 days (d), sample cracking was checked every other day for each sample, and then checked once per week. The cracking time was recorded when some cracks were observed to form in the coatings.

### Thermal Cycle Test

Each formulation was coated as 100-μm thick film, followed by curing at room temperature or 150° C., then aged at 300° C. for 10 d. Then, the samples were subjected to 100 cycles of temperature cycling between −50° C. and 150° C. at a temperature ramping rate 20 C°/min, 10 min per cycle, using a Tenney Thermal Chamber. A coated sample was deemed to pass the thermal cycle test if no cracks or delamination were observed after completion of the test.

Table 1 illustrates the results of cracking time for samples with and without mica. In each examples the weight-to-weight units of the resin to units of the PPhMS or PDMS polymer was 45:55. TCT refers to thermal cycle test. Mica/wt % refers to the wt % of mica based on the weight of the copolymer and the mica. MRX refers to MRX muscovite mica, and C-4000 refers to C-4000 muscovite mica.

TABLE 1
Crack time and Thermal Cycle Test Results for Coatings

| Ex. | Resin | Polymer (DP) | Mica/wt % | Crack Time (d) | TCT |
|---|---|---|---|---|---|
| 1 | Resin 1 | PPhMS (140) | MRX/50% | 100 | pass |
| 2 | Resin 2 | PPhMS (140) | MRX/50% | 100 | pass |
| 3 | Resin 1 | PDMS (80) | C-4000/50% | 63 | pass |
| C1 | Resin 1 | PPhMS (140) | No mica | 18 | fail |
| C2 | Resin 2 | PPhMS (140) | No mica | 17 | fail |
| C3 | Resin 1 | PDMS (80) | No mica | 4 | fail |

The results show a dramatic difference in crack time and thermal cycle testing results for blends that contained mica versus mica free samples. Testing for crack time was stopped at 100 days.

The combination of the PPhMS or PDMS and mica alone delaminated readily from the substrate at 300° C. Moreover, of the fillers tested-silica, calcium carbonate, aluminum silicate, calcium silicate, alumina, ferric oxide, and mica-mica was found to be the only class of fillers to exhibit crack times beyond 120 h.

1. A composition comprising a mixture of a mica and a T^{R}-D^{R′R′}-(R″MeSiO_{2/2})ₙ copolymer, where each R, R′, and R″ are independently methyl or phenyl, wherein n is in the range of from 2 to 800, wherein the weight-to-weight ratio of the T^{R}_D^{R′R′}-(R″MeSiO_{2/2})ₙ copolymer to the mica is in the range of from 10:90 to 90:10.

2. The composition of claim 1 which further comprises a sufficient concentration of an aprotic solvent to achieve a composition Brookfield viscosity at 25° C. in the range of from 20 cP to 10,000 cP.

3. The composition of claim 2 wherein the weight-to-weight ratio of the mica to the T^{R}-D^{R′R′}-(R″MeSiO_{2/2})ₙ copolymer is in the range of from 20:80 to 80:20; wherein the concentration of the aprotic solvent is sufficient to achieve a Brookfield viscosity at 25° C. in the range of from 50 cP to 5,000 cP.

4. The composition of claim 3 wherein the weight-to-weight ratio of the mica to the T^{R}-D^{R′R′}-(R″MeSiO_{2/2})ₙ copolymer is in the range of from 30:70 to 70:30; and wherein the mica is muscovite, biotite, fuchsite, phlogopite, margarite, glauconite, or lepidolite; wherein the concentration of the aprotic solvent is sufficient to achieve a Brookfield viscosity at 25° C. in the range of from 100 cP to 1200 cP.

5. The composition of claim 4 wherein n is in the range of from 5 to 300; the mica is muscovite or phlogopite; and the weight-to-weight ratio of the T^{R}-D^{R′R′}-(R″MeSiO_{2/2})ₙ copolymer to the mica is in the range of from 65:35 to 35:65.

6. The composition of claim 5 wherein the mica is muscovite.

7. The composition of claim 1 which further comprises R²Si(OR³)₃, where R² is C₁-C₁₂-alkyl or aryl; and R³ is C₁-C₄-alkyl; and a moisture cure catalyst.

8. The composition of claim 7 wherein R²Si(OR₃)₃ is methyltrimethoxysilane or phenyltrimethoxysilane; the aprotic solvent is propylene glycol methyl ether acetate, ethyl acetate, propyl acetate, butyl acetate or propyl propionate; and the moisture cure catalyst is a tin-based or a titanium-based catalyst.

9. A process comprising the steps of coating a substrate with the composition of claim 7 then curing the coating.

10. An article comprising a substrate and a coating having a thickness in the range of from 20 μm to 300 μm disposed thereupon, where the coating comprises a cured composition of claim 7.
